(19) United States
(12) Patent Application Publication
(10) Pub. No.: US 2026/0023956 A1
(43) Pub. Date: Jan. 22, 2026

(54) ULTRA-LOW PRECISION WEIGHT QUANTIZATION OF MACHINE LEARNING MODEL

(71) Applicant: Microsoft Technology Licensing, LLC, Redmond, WA (US)

(72) Inventors: Shuming MA, Beijing (CN); Li DONG, Beijing (CN); Shaohan HUANG, Beijing (CN); Wenhui WANG, Beijing (CN); Furu WEI, Beijing (CN); Jilong XUE, Beijing (CN); Lingxiao MA, Beijing (CN); Hongyu WANG, Beijing (CN)

(73) Assignee: Microsoft Technology Licensing, LLC, Redmond, WA (US)

(21) Appl. No.: 18/774,786

(22) Filed: Jul. 16, 2024

(51) Int. Cl. G06N 3/0495; G06N 3/045

(52) U.S. Cl. CPC G06N 3/0495; G06N 3/045

(57) ABSTRACT

A computer system is provided that includes processing circuitry. The computer system being configured to implement a machine learning (ML) model having a transformer architecture that, during a training operation or inference operation, is configured to receive an activation input matrix of activation input values and obtain a weight matrix of weight values. The ML model is further configured to perform ultra-low precision (ULP) quantization by quantizing each of the weight values in the weight matrix to a corresponding selected value from a predefined set of binary or ternary quantized weight values and compute a matrix arithmetic result based on at least a portion of the weight matrix with the quantized weight values and at least a portion of the activation input matrix.

### BACKGROUND

One type of generative machine learning model that has received attention recently is the Large Language Models (LLM). LLMs have achieved remarkable progress in recent years, pushing the boundaries of natural language processing and generation. LLMs have demonstrated impressive performance across a wide range of tasks, including language understanding, translation, summarization, and question answering. These models are trained on vast amounts of text data using self-supervised learning techniques, allowing them to capture rich linguistic knowledge and generate human-like text. The growth of LLMs can be attributed to their ability to learn from extremely large datasets, their deep and complex architectures, and the use of advanced techniques like transformer architectures and attention mechanisms. Yet, LLMs, like many generative machine learning field, consumes copious amounts of compute resources and energy. Opportunities exist for overcoming technical challenges associated with developing more efficient modes of training and inference using LLMs.

### SUMMARY

To address the issues discussed herein, computer systems and methods are provided. In one aspect, a computer system is provided that includes processing circuitry configured to implement a machine learning (ML) model having a transformer architecture that, during a training operation or inference operation, is configured to receive an activation input matrix of activation input values and obtain a weight matrix of weight values. The ML model is further configured to perform ultra-low precision (ULP) quantization by quantizing each of the weight values in the weight matrix to a corresponding selected value from a predefined set of binary or ternary quantized weight values and compute a matrix arithmetic result based on at least a portion of the weight matrix with the quantized weight values and at least a portion of the activation input matrix.

In another aspect, the processing circuitry of the computer system is distributed across multiple computing devices each configured to implement an instance of the machine learning model. The weight matrix and activation input matrix are divided into a plurality of weight subgroups and activation input subgroups, respectively. Each of the computing devices receives a corresponding weight subgroup and activation input subgroup for performing matrix arithmetic in parallel at least during training. Each computing device is configured to perform weight subgroup quantization and weight subgroup normalization, and activation subgroup quantization and activation subgroup normalization during the parallel matrix arithmetic.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 shows a schematic view of an example machine learning model with a transformer architecture, which may be suitable for an implementation of the ultra-low precision weight quantization technology described herein.

FIG. 2 shows a schematic view of an example internal configuration of a transformer architecture 120 of FIG. 1.

FIG. 3 shows a schematic view of an example linearization layer that employs an implementation of the ULP weight quantization technology as described herein.

FIG. 4 shows a flowchart of a computerized method according to one example implementation of the present disclosure.

FIG. 5 shows a flowchart of a computerized method according to one example implementation of the present disclosure.

FIG. 6 schematically shows a non-limiting embodiment of a computing system that can enact one or more of the methods and processes described herein.

### DETAILED DESCRIPTION

A large language model (LLM) is a type of generative machine learning model that is trained on a next work prediction task, using extremely large training datasets. Recently LLMs have been developed that generate human-like text for various natural language processing tasks, such as text completion, question answering, and language translation. Most large language models employ a pre-trained transformer-based model, which may an encoder/decoder, encoder only, or decoder only architecture. The large language model is configured to receive input that includes natural language text and generate output that includes natural language text in response to the input. Typically, the natural language text is tokenized using a tokenizer, such as the BERT (Bidirectional Encoder Representations from Transformers) tokenizer, to generate an embedding representation of the input. The embedding representation includes a series of input tokens and is typically of fixed length. The encoder includes a multi-headed attention unit configured to compute scaled dot product attention between each of the tokens in the series of input tokens, and a feed forward network configured to have its weights adjusted during pre-training or fine tuning and fixed during inference.

The parameter size of LLMs has grown recently from several million to billions of parameters. LLMs capable of receiving inputs in different modalities have also be developed. Thus the example LLMs discussed herein can be multi-modal generative models configured to receive multi-modal input including natural language text input as a first mode of input and image, video, or audio as a second mode of input, and generate output including natural language text based on the multi-modal input. The output of the multi-modal model may additionally include a second mode of output such as image, video, or audio output.

The rapid growth of large language models has led to significant improvements in various tasks. However, it can be expensive to host large language models due to the high inference costs and energy consumption. As the size of these models grows, the memory bandwidth required for accessing and processing the model parameters becomes a major bottleneck, limiting the overall inference performance. Moreover, when deploying these models on distributed systems or multi-device platforms, the inter-device communication overhead can significantly impact the inference latency and energy consumption.

Post-training model quantization has emerged as a promising solution, as it can significantly reduce the memory footprint and computational cost of large-scale models while maintaining competitive performance. Post-training model quantization is a technique used to reduce the size and computational requirements for inference with LLMs. It involves post-training conversion of the model's parameters (e.g., weights and activations) from higher-precision floating-point numbers (e.g., 32-bit) to lower-precision fixed-point numbers (e.g., 8-bit).

The main benefits of quantization include reduced model size, faster inference, and lower memory requirements during inference. By using fewer bits to represent each parameter, the overall model size is significantly reduced, making it easier to deploy the model on resource-constrained devices like mobile phones or edge devices. Lower-precision operations can be executed more efficiently on hardware, leading to faster inference times. Quantized models require less memory during inference, which is particularly beneficial for running multiple models concurrently or on devices with limited memory.

Post-training quantization approaches are often employed because they are simple and easy to apply since it does not require any changes to the training pipeline or retraining the model. However, it will result in a more significant loss of accuracy especially when the precision goes lower, because the model is not optimized for the quantized representation during training.

Another strand of quantizing deep neural networks is quantization-aware training. Quantization-aware training is a technique that incorporates the quantization process directly into the training loop of LLMs. This is done to simulate the inference-time behavior of the quantized model during training. By allowing the training process to account for quantization errors and optimize weights accordingly, quantization-aware training produces quantized models with higher accuracy compared to post-training quantization methods.

Compared to post-training approaches, quantization-aware training typically results in better accuracy, as the model is trained to account for the reduced precision from the beginning. Moreover, it allows the model to continue-train or do fine-tuning, which is beneficial for LLMs. The challenge of quantization-aware training mainly lies in optimization, i.e., the model becomes more difficult to converge as the precision goes lower. Besides, it is unknown whether quantization-aware training follows the scaling law of neural language models.

The technology described herein introduces ultra-low-precision (“ULP”) weight quantization of LLMs, which utilizes either a binary (e.g., 0, 1) quantization or ternary (e.g., −1, 0, +1) quantization. The binary quantization approach utilizes a 1-bit transformer architecture for LLMs. The ternary quantization approach utilizes a so-called 1.58-bit transformer architecture for LLMs. Each approach aims to scale efficiently in terms of both memory and computation. The ULP weight quantization technology described herein employs low-precision binary or ternary weights and quantized activations, while maintaining high precision for the optimizer states and gradients during training.

The ternary quantization approach has a stronger modeling capability due to its explicit support for feature filtering, made possible by the inclusion of an additional value (e.g., 0) in the model weights, which can improve the performance of the ternary quantization approach. Experimentation has shown that the ternary quantization approach can match full precision (e.g., FP16) baselines in terms of both perplexity and end-task performance, starting from a 3B size, when using the same configuration (e.g., model size, training tokens, etc.)

Typically, LLMs employ 16-bit floating values, such as e.g., FP16 (16-bit floating point) and BF16 (bfloat16). The bulk of the computations of an LLM involve matrix multiplication. Therefore, the major computation cost comes from the floating-point addition and multiplication operations. In contrast, the matrix multiplication of the ULP weight quantization technology, as described herein, only involves integer addition, which saves orders of energy cost for LLMs. As the fundamental limit to compute performance in many chips is power, the energy savings can also be translated into faster computation.

In addition to computation, the process of transferring model parameters from DRAM (i.e., dynamic random-access memory) to the memory of an on-chip accelerator (e.g., SRAM) can be expensive during inference. There have been attempts to enlarge SRAM to improve throughput, but this introduces significantly higher costs than DRAM.

Compared to full-precision (e.g., 16-bit) models, LLMs that utilize the technology described herein have a much lower memory footprint from both a capacity and bandwidth standpoint. This can significantly reduce the cost and time of loading weights from DRAM, leading to faster and more efficient inference.

This approach is designed to be scalable and stable, with the ability to handle large language models efficiently. The implementation of the ULP weight quantization technology replaces linear projections (e.g., nn.Linear in PyTorch™) in the transformer with a technique referred to as “ULP-Linear” herein. Furthermore, this approach complements other acceleration methods for LLMs, such as PagedAttention, FlashAttention, and speculative decoding.

Experimental results demonstrate that ULP weight quantization technology, as described herein, achieves competitive performance in terms of both perplexity and downstream task accuracy. Furthermore, this technology significantly reduces memory footprint and energy consumption compared to the baselines.

In addition, the ULP weight quantization technology follows a scaling law similar to that of full-precision transformers, indicating that it can be effectively scaled to even larger language models with potential benefits in terms of performance and efficiency.

With the ternary quantization technology, as described herein, the parameters are ternary, taking on values of {−1, 0, 1}. Compared to the binary approach, the ternary approach has an additional value of 0. This results in 1.58 bits in the binary system. 1.58 bits are determined by calculating the log (base 2) of 3. Furthermore, the ternary ULP weight quantization technology offers two additional advantages over the binary approach.

Firstly, its modeling capability is stronger due to its explicit support for feature filtering, made possible by the inclusion of 0 in the model weights, which can significantly improve the performance of LLMs. Secondly, the ternary ULP weight quantization technology can match full precision (e.g., FP16) baselines in terms of both perplexity and end-task performance, starting from a 3B size (approximately three billion parameters), when using the same configuration (e.g., model size, training tokens, etc.).

A ULP weight quantization approach uses the same layout of typical transformers, stacking blocks of self-attention and feed-forward networks. Compared with a typical transformer, a binary ULP weight quantization approach uses ULP-Linear processing (Eq. 14) instead of conventional matrix multiplication. The ULP-Linear processing employs binarized (i.e., 1-bit) or ternary (i.e., 1.58-bit) model weights.

The other components may remain high-precision, such as 8-bit for activations. This can be so mainly for three reasons: First reason is that the residual connections and the layer normalization contribute negligible computation costs to LLMs. Second reason is the computation cost of QKV (Query, Key, Value) transformation is much smaller than the parametric projection as the model grows larger. The third reason that the other components may remain high-precision is because the precision is preserved for the input/output embedding because the language models use the high-precision probabilities to perform sampling.

The QKV transformation is a part of the self-attention mechanism in transformer models. It involves transforming the input sequence into queries, keys, and values, where the queries are compared against the keys to determine relevance scores that are used to weight and selectively retrieve the values. This allows the model to dynamically focus on the most relevant parts of the input sequence for a given context.

The binary quantization approach, as described herein, first binarizes the weights to either +1 or −1 with a signum function, which gives the sign (e.g., + or −) of a value x. The ULP-Linear technique centralizes the weights to be zero-mean before binarization to increase the capacity within a limited numerical range. A scaling factor β is used after binarization to reduce an l2 error between the real-valued and the β binarized weights. With binarization, a is the mean of the matrix of the weight parameters. The binarization of a weight W ∈ [symbol] can be formulated as:

$$\tilde{W} = Sign ( W - α ) , \qquad ( 1 )$$

$$Sign ( {W}_{ij} ) = \{ \begin{matrix}+ 1 , if {W}_{ij} > 0 , \\ - 1 , if {W}_{ij} \leq 0\end{matrix} , \qquad ( 2 )$$

$$α = \frac{1}{n m} \sum {W}_{ij} \qquad ( 3 )$$

With the ternary quantization approach, the weights are constrained to −1, 0, or +1 by using the absmean quantization function. With binarization, lowercase gamma (γ) is the mean of the matrix of the weight parameters. The ternary quantization approach first scales the weight matrix by its average absolute value, and then round each value to the nearest integer among {−1, 0,+1}:

$$\tilde{W} = RoundClip ( \frac{W}{γ + ϵ} , - 1 , 1 ) , \qquad ( 4 )$$

RoundClip(x,a,b)=max(a, min(b,round(x))), (5)

$$γ = \frac{1}{nm} {\sum }_{i j} \vert {W}_{i j} \vert \qquad ( 6 )$$

For the binary quantization approach, the activations are quantized to b-bit precision using absmax technique. Absmax, also known as the absolute value of the maximum, refers to a technique used in machine learning for mitigating the vanishing gradient problem in neural networks. The absmax technique may scale activations into the range [−Q_{b},Q_{b}](Q_{b}=2^{b-1}) by multiplying with Q_{b} and dividing by the absolute maximum of the input matrix:

$$\tilde{x} = Quant ( x ) = Clip ( x \times \frac{{Q}_{b}}{γ} , {Q}_{b} + ∈ , {Q}_{b} - ∈ ) , \qquad ( 7 )$$

$$Clip ( x , a , b ) = max ( a , min ( b , x ) ) , γ = {‖ x ‖}_{∞} , \qquad ( 8 )$$

where ϵ is a small floating-point number that prevents overflow when performing the clipping.

For the ternary quantization approach, the quantization function for activations follows the same implementation in binary quantization approach, except that the activations are not scaled before the non-linear functions to the range [0,Qb]. Instead, the activations are all scaled to [−Q_{b}, Q_{b}] per token to get rid of the zero-point quantization. This is more convenient and simpler for both approaches and system-level optimization, while introducing negligible effects to the performance in the experiments.

For the activations before the non-linear functions (e.g., rectified linear unit (ReLU)), the binary quantization approach, described herein, scales them into the range [0,Q_{b}] by subtracting the minimum of the inputs so that all values are non-negative:

$$\tilde{x} = Quant ( x ) = Clip ( ( x - η ) \times \frac{{Q}_{b}}{γ} , ∈ , {Q}_{b} - ∈ ) , η = {min}_{ij} {x}_{ij} \qquad ( 9 )$$

With the technology described herein, the quantization is performed per tensor during training while per token during inference for both stability and efficiency. A tensor is an array or data structure that contains the numerical weights and biases in the neural network architecture. These tensors are optimized during the training process to capture patterns and relationships in the training data, allowing the model to generate relevant and coherent outputs. A token refers to the basic unit of text that the model processes and generates. It can be a word, subword, character, or byte pair encoding, depending on the tokenization method used during the model's training. Tokens serve as the inputs and outputs of the LLM, enabling it to understand and produce human-readable text. Inference refers to the process of using a trained model to generate outputs or predictions based on new input data. Specifically, during inference, the LLM takes in a sequence of tokens (e.g., words or subwords) as input and calculates probability distributions over the possible next tokens using the model's weights and architecture. This allows the model to generate coherent and relevant text continuations or responses to prompts.

With the quantization equations provided above, the matrix multiplication of an implementation of the ULP weight quantization approach may be represented like this:

$$y = \tilde{W} \tilde{x} \qquad ( 10 )$$

This presumes that the elements in W and x are mutually independent and share the same distribution, and W and x are independent of each other. Then the variance of the output y is estimated as:

$$Var ( y ) = n Var ( \tilde{w} \tilde{x} ) \qquad ( 11 )$$

$$= nE \vert {\tilde{w}}^{2} \vert E \vert {\tilde{x}}^{2} \vert \qquad ( 12 )$$

$$= n {β}^{2} E \vert {\tilde{x}}^{2} \vert \approx E \vert {\tilde{x}}^{2} \vert \qquad ( 13 )$$

For the full-precision computation, the variance of the output Var(y) is at the scale of 1 with the standard initialization methods (e.g., Kaiming initialization or Xavier initialization), which has a great benefit to the training stability. A layer normalization (i.e., LayerNorm) function is performed before the activation quantization to preserve the variance after quantization. LayerNorm is a normalization technique that normalizes the activations across the features (e.g., neurons) in each layer of the deep neural network, helping to stabilize and accelerate training by mitigating internal covariate shift in very deep models.

In this way, the variance of the output y is then estimated as Var(y)≈E[LN(\tilde{x})²]=1, which has the same magnitude as the full-precision counterpart Var(y). In the context of transformers, one or more implementations may employ a sublinear layer normalization (“SubLN”), which is a variant of the standard LayerNorm technique used in LLMs. SubLN is a layer normalization method that applies different normalization scales to different groups of features (e.g., neurons) within a layer based on their activation magnitudes. This allows the normalization to be less aggressive for extremely small or large activations compared to LayerNorm, better preserving information for infrequent tokens or features.

The ULP weight quantization approaches described herein employ SubLN into the ULP-Linear processing, which is formulated as:

$$y = \tilde{W} \tilde{x} = \tilde{W} Quant ( LN ( x ) ) \times \frac{{β}_{γ}}{{Q}_{b}} \qquad ( 14 )$$

$$LN ( x ) = \frac{x - E ( x )}{\sqrt{Var ( x ) + ∈}} , β = \frac{1}{nm} {‖ W ‖}_{1} \qquad ( 15 )$$

After the SubLN operation, the activations are quantized with the absmax function. The matrix multiplication is performed between the 1-bit weights and the quantized activations. The output activations are rescaled with {β, γ} to dequantize them to the original precision.

LLaMA-like Components. The architecture of LLaMA (acronym for Large Language Model Meta AI) has been a defacto backbone for many open-source LLMs. To embrace the open-source community, the ULP-quantization approaches described herein may adopt the LLaMA-like components. Specifically, an implementation may employ RMSNorm (Root Mean Square Layer Normalization), SwiGLU (Swish-Gated Linear Unit), rotary embeddings, and remove all biases.

Model parallelism with Group Quantization and Normalization. One technique to scale up LLM is model parallelism, which splits the layers or components of an LLM across different devices (e.g., hardware accelerators). Doing so allows for the training or inference of models that are too large to fit on a single device's memory. With model parallelism partitions, the matrix multiplication may be partitioned across multiple devices. With typical model parallelism approaches, the tensors are independent along the partition dimension. However, since the parameters α, β, γ, and η are typically calculated from the whole tensors, tensors are not always independent along the partition dimension.

To address this issue, one may introduce an all-reduce operation for each parameter. The all-reduce operation combines gradients or weight updates from multiple workers or devices by summing or averaging them, ensuring all devices have the updated model weights after each training iteration. This enables efficient data-parallel training of extremely large LLMs across a cluster. However, even though the communication for each parameter is small, the amount of synchronization is growing as the model becomes deeper, which significantly slows the forward pass. The problem also exists in SubLN, where the mean and the variance should be estimated across the partition dimension.

To address these concerns, the technology described herein offers an approach that makes the model parallelism more efficient. The technology described herein may divide the weights and activations into groups and then independently estimate each group's parameters.

This way, the parameters can be calculated locally without requiring additional communication. This approach is called group quantization, herein.

For a weight matrix W ∈ [symbol] , group quantization technology divides it into G groups along the partition dimension, and each group has a size of

$$\frac{n}{G} \times m .$$

The group quantization technology then estimates the parameters for each group independently:

$${α}_{g} = \frac{G}{nm} {\sum }_{ij} {W}_{ij}^{( g )} , {β}_{g} = \frac{G}{nm} {‖ {W}^{( g )} ‖}_{1} , \qquad ( 16 )$$

where W⁽⁸⁾ denotes the g-th group of the weight matrix. Similarly, for the activations, the group quantization technology can divide the input matrix x ∈ [symbol] into G groups and calculate the parameters for each group:

$${γ}_{g} = {‖ {x}^{( g )} ‖}_{∞} , η = {min}_{ij} {x}_{ij}^{( g )} \qquad ( 17 )$$

For LN, the group quantization technology can apply a group normalization technique to compute the mean and variance for each group independently. Group normalization in LLMs is a normalization technique that divides the channels (e.g., features) into groups and performs normalization across the groups, instead of across all channels as in layer normalization. Group normalization splits the channels into groups, computes the mean and variance statistics for each group, and normalizes the features within each group. This adds more flexibility compared to layer normalization by allowing different feature groups to have different normalized statistics. Herein, this may be accomplished in this manner:

$$LN ( {x}^{( g )} ) = \frac{{x}^{( g )} - E ( {x}^{( g )} )}{\sqrt{Var ( {x}^{( g )} ) + ∈}} \qquad ( 18 )$$

In this way, the technology described herein can efficiently implement model parallelism with group quantization and normalization. Thus, additional communication is not necessary, and it can scale to large language models.

Straight-Through Estimator (STE). To train a 1-bit model of the binary quantization technology, a straight-through estimator (STE) may be employed to approximate the gradient during backpropagation. A STE approximates the nondifferentiable sampling operation as an identity function during the backward pass (i.e., backpropagation), while performing the actual discrete sampling in the forward pass. This allows gradients to flow through the sampling step for training the model parameters.

The technology described herein bypasses the nondifferentiable functions, such as the Sign (Eq. 2) and Clip (Eq. 8) functions, during the backward pass. A nondifferentiable function is one whose output cannot be differentiated with respect to its inputs, preventing direct use of backpropagation for training. STE allows gradients to flow through the network without being affected by these nondifferentiable functions, making it possible to train a quantized model of the technology described herein.

Mixed precision training. While the weights and the activations are quantized to ultra-low precision (e.g., binary or ternary), the gradients and the optimizer states are stored in high precision (e.g., 8-bits or more) to ensure training stability and accuracy. The technology described herein maintains a latent weight in a high-precision format for the learnable parameters to accumulate the parameter updates. The latent weights are quantized (e.g., binarized or ternarized) on the fly during the forward pass and not used for the inference process.

Large learning rate. During the optimization, the small update on the latent weights often makes no difference in the ultra-low quantized (e.g., 1-bit or 1.58-bit) weights. This results in a biased gradient and update which are estimated based on the ultra-low quantized weights. This challenge is even worse at the beginning of the training, where the models are supposed to converge as fast as possible.

The technology described herein may address this challenge by increasing the learning rate to accelerate the optimization. Experiments were conducted and show that the technology described herein benefits from a large learning rate in terms of convergence, while the typical FP16 transformer diverges at the beginning of training with the same learning rate.

Computational Efficiency. Computational efficiency is expressed herein in terms of both arithmetic operations energy and memory footprint. Herein, the main focus regarding computational efficiency is on the calculation for the matrix multiplication, since it contributes the most to the cost of LLMs.

Arithmetic operations energy. Herein, “energy model” refers to the energy consumption for different arithmetic operations, which can be estimated in accordance with Table 1 below:

TABLE 1

| | Add | Ê_{add} | MUL | Êₘᵤₗ |
|---|---|---|---|---|
| | Energy | (pJ) | Energy | (pJ) |
| Bits | 45 nm | 7 nm | 45 nm | 7 nm |
| FP32 | 0.9 | 0.38 | 3.7 | 1.31 |
| FP16 | 0.4 | 0.16 | 1.1 | 0.34 |
| INT8 | 0.03 | 0.007 | 0.2 | 0.07 |

In typical transformers, for matrix multiplication with dimensions m×n and n×p, the energy consumption can be calculated as follows:

$${E}_{add} = m \times ( n - 1 ) \times p \times {\hat{E}}_{add} \qquad ( 19 )$$

$${E}_{mul} = m \times n \times p \times {\hat{E}}_{mul} \qquad ( 20 )$$

For ULP-Linear, the energy consumption of the matrix multiplication is dominated by the addition operations, as the weights are binary or ternary. The multiplication operations are applied to scale the output with the scalars β and

$$\frac{γ}{{Q}_{b}} ,$$

so the energy consumption for multiplication can be computed as:

$${E}_{mul} = ( m \times p + m \times n ) \times {\hat{E}}_{mul} \qquad ( 21 )$$

which is significantly smaller than that in typical transformers. The energy savings of implementation of the ULP weight quantization described herein (which use, for example, 1-bit or 1.58-bit weights and 8-bit activations) compared to a full-precision (32-bit weights and 32-bit activations) and half-precision (16-bit weights and 16-bit activations) transformer are shown in Table 2 below.

TABLE 2

| | | 7 nm | 7 nm | 45 nm | 45 nm |
|---|---|---|---|---|---|
| | | Energy | Energy | Energy | Energy |
| | Weight | (J) | (J) | (J) | (J) |
| Size | bits | MUL | ADD | MUL | ADD |
| 6.7B | 32 | 4.41 | 1.2 | 12.46 | 3.03 |
| | 16 | 1.14 | 0.54 | 3.70 | 1.35 |
| | 1 | 0.02 | 0.04 | 0.08 | 0.13 |
| 13B | 32 | 8.58 | 2.49 | 24.23 | 5.89 |
| | 16 | 2.23 | 1.05 | 7.2 | 2.62 |
| | 1 | 0.04 | 0.06 | 0.12 | 0.24 |
| 30B | 32 | 20.09 | 5.83 | 56.73 | 13.80 |
| | 16 | 5.21 | 2.45 | 16.87 | 6.13 |
| | 1 | 0.06 | 0.14 | 0.20 | 0.53 |

As can be seen, binary (i.e., 1-bit) quantization approach provides significant energy savings, especially for the multiplication operations, which are the major component of the matrix multiplication energy consumption.

Comparison with FP16 Transformers. For this comparison, a series of autoregressive language models with ULP weight quantization are trained. The models vary in size, ranging from 125M to 30B. They are trained on an English-language corpus, which consists of the PILE (Polynomial Inverse Linear Embeddings) dataset, Common Crawl snapshots, RealNews, and CC-Stories datasets. In this comparison, a Sentencpiece tokenizer is employed to preprocess data and the vocabulary size is 16K. Besides ULP weight quantization, the transformers are trained on baselines with the same datasets and settings for a fair comparison.

Inference-Optimal Scaling Law. Neural language models have proven to scale predictably with typical transformer architecture. The loss scales as the power law with the amount of computation used for training.

This allows for a determination of the optimal allocation of a computation budget as well as for a prediction of the performance of large language models from smaller models. To study the scaling law of binarized transformer of a binary quantization, the scaling curve of both ULP weight quantization and the FP16 Transformer baseline are plotted against the parameter count. The number of training tokens may be fixed or varied by the model sizes. The scaling law is fit with an irreducible loss term:

$$L ( N ) = {aN}^{b} + c \qquad ( 22 )$$

To evaluate whether the scaling law can accurately predict the loss, the models from 125M to 6.7B are examined to see if fit the parameters in the power-law and use the law to predict the loss of 13B and 30B. It shows that the fitted scaling law predicted ULP weight quantization's loss with high accuracy. Besides, the gap between ULP weight quantization and FP16 transformer becomes smaller as the model size grows.

While the power-law above measures the trend of the scaling of ULP weight quantization, it does not properly model the relationship between the loss and the actual compute. Some may estimate the compute by calculating the FLOPs. FLOPs (Floating Point Operations) is a measure of the number of arithmetic operations, such as additions, multiplications, etc., performed by a computer hardware or software system. It provides an estimate of the computational complexity or computational cost involved in executing an algorithm or program. FLOPs are commonly used to benchmark and compare the performance of different computer processors, hardware accelerators (like GPUs), and machine learning models.

However, FLOPs do not apply well to 1-bit or 1.58-bit models whose cost is dominated by integer computation. Moreover, FLOPs mainly measure the training computation rather than the inference. To have a better understanding of the scaling efficiency of neural language models, Inference-Optimal Scaling Law is introduced herein. It predicts the loss of energy consumption. This focuses on the inference energy cost as it scales with the usage of the model, while the training cost is only once.

ULP weight quantization has much higher scaling efficiency than the state of the art. Given a fixed computation budget, ULP weight quantization achieves a significantly better loss. Meanwhile, the inference cost is much smaller to get the same performance as the FP16 models.

Compared with loss, capacity is more difficult to predict due to the emergent nature of neural language models. To evaluate the capabilities with the interpretable metrics, both the zero-shot and 4-shot learning results were tested on four downstream tasks. Zero-shot learning in LLMs refers to the ability of the model to perform a new task solely based on the instructions or task description, without any additional training data or examples for that specific task. 4-shot learning involves providing a LLM with four examples of a task before asking the model to perform the task.

Similar to the loss scaling curve, the performance on the downstream tasks can scale as the computation budget grows. Besides, the scaling efficiency of capabilities is much higher than the FP16 transformer approach baseline, in terms of both zero-shot and few-shot performance.

Stability Test. A major challenge for training low-bit transformers is the stability in optimization. Therefore, stability tests to determine both ULP weight quantization and the FP16 approach baselines is performed by training a series of models with varying peak learning rates. The ULP weight quantization approach can converge with a large learning rate while FP16 transformer approach cannot, demonstrating better training stability of ULP weight quantization approach. This advantage in optimization enables the training with larger learning rates. The ULP weight quantization approach can benefit from the increase in learning rate, achieving better convergence in terms of perplexity (PPL), which refers to a metric that measures how well a probabilistic model predicts a sample of text data.

Comparison with Post-training Quantization. ULP weight quantization model may be compared with typical post-training quantization (such as Absmax, SmoothQuant, GPTQ, and QuIP) over an FP16 transformer model, which follows the same training setting and data as the ULP weight quantization model.

Absmax quantization determines the quantization range for weight parameters in language models by using the maximum absolute value across all weights as the symmetric range bounds. SmoothQuant is a quantization technique for language models that smoothly redistributes the quantization ranges across different layers to minimize accuracy loss. GPTQ is an open-source library that enables quantization of pre-trained language models like GPT to compressed low-precision integer formats without retraining. QuIP (Quantization with Input Parallelism) is a technique that partitions and quantizes large language models across multiple devices to enable efficient inference on hardware with limited memory capacity.

Some post-training quantization approaches (e.g., Absmax and SmoothQuant) quantize both the weights and the activations, while others (e.g., GPTQ and QuIP) only reduce the precision of weights. For the comparison, various quantization levels are employed. For the weight-only quantization (e.g., GPTQ and QuIP), W4A16 (i.e., 4-bit weight and 16-bit activation) and W2A16 (i.e., 2-bit weight and 16-bit activation) are used. For weight-and-activation quantization (e.g., Absmax and SmoothQuant), the FP16 Transformer model is quantized to W8A8, W4A4, and W1A8. For this comparison, the implementation of ULP weight quantization model involves a binary weight with 8-bit activation (W1A8), which has lower or equal bits than the baselines.

Table 3 presents a detailed comparative analysis of the zero-shot performance of an implementation of the ULP weight quantization model, as described herein, against various baseline approaches on four benchmark datasets, namely WinoGrande (WGe), Winograd (WG), Storycloze (SC), and Hellaswag (HS). In this comparison, all models have the model sizes of 6.7B for a fair comparison.

The WinoGrande dataset is a large collection of fill-in-the-blank pronoun resolution problems designed to evaluate the commonsense reasoning abilities of language models based on their ability to resolve ambiguous pronouns using real-world knowledge and context. The Winograd dataset is a collection of sentence pairs with a pronoun that must be resolved using commonsense reasoning to determine which noun the pronoun refers to. The StoryCloze dataset consists of short multi-sentence stories where the last sentence has a blanked-out word or phrase that needs to be filled in. It tests a language model's ability to understand the narrative and use commonsense reasoning to predict the missing component based on the context of the story. HellaSwag is a dataset testing a language model's commonsense reasoning ability by having it select the most plausible continuation statement from multiple choices given a brief situation description.

In Table 3, Wbits are bits of weights, PTQ is Prompting for Transfer on Question Answering, Avg is average, and ULP Quant is an implementation of the ULT quantization model as described herein. PTQ (Prompting for Transfer on Question Answering) is an approach where LLMs are prompted with examples from a question-answering dataset to allow rapid transfer and adaptation to that task without any fine-tuning.

TABLE 3

| Wbits | Approaches | PTQ | PPL↓ | WG↑ | WGe↑ | HS↑ | SC↑ | Avg↑ |
|---|---|---|---|---|---|---|---|---|
| 16 | Random | û | — | 50.0 | 50.0 | 25.0 | 50.0 | 43.8 |
| | Transformer | û | 15.19 | 66.7 | 54.3 | 42.9 | 67.4 | 57..8 |
| 8 | Absmax | ü | 21.43 | 60.4 | 52.0 | 38.3 | 62.7 | 53.4 |
| | SmoothQuant | ü | 15.67 | 65.3 | 53.1 | 40.9 | 67.6 | 56.7 |
| 4 | GPTQ | ü | 16.05 | 57.2 | 51.2 | 39.9 | 63.4 | 52.9 |
| | Absmax | ü | 4.8e4 | 55.8 | 50.9 | 25.0 | 53.1 | 46.2 |
| | SmoothQuant | ü | 1.6e6 | 53.7 | 48.3 | 24.8 | 53.6 | 45.1 |
| 2 | GPTQ | ü | 1032 | 51.6 | 50.1 | 25.8 | 53.4 | 45.2 |
| | QuIP | ü | 70.43 | 56.1 | 51.2 | 30.3 | 58.4 | 49.0 |
| 1 | Absmax | ü | 3.5e23 | 49.8 | 50.0 | 24.8 | 53.6 | 44.6 |
| | SmoothQuant | ü | 3.3e21 | 50.5 | 49.5 | 24.6 | 53.1 | 44.4 |
| 1 | ULP Quant | û | 17.07 | 66.3 | 51.4 | 38.9 | 66.9 | 55.9 |

As shown in Table 3, the approaches are evaluated across several weight bit levels, spanning from 16 down to 1. Besides the zero-shot accuracy on the downstream tasks, the evaluation metrics include language model perplexity on the validation set, which provides a comprehensive understanding of each approach's performance.

The results demonstrate the effectiveness of an implementation of the QLP quantization technology in achieving competitive performance levels compared to the baseline approaches, particularly for ultra-low bit levels (e.g., 1 bit). The zero-shot scores of an implementation of the QLP quantization technology are comparable with the 8-bit models, while the inference cost is much lower. For the 4-bit models, the weight-only quantization methods outperform the weight-and-activation quantizers, mainly because the activation is more difficult to quantify. A binary implementation of the QLP quantization technology, as a 1-bit model, significantly achieves better results than both the weight-and-activation quantization methods and the weight-only methods. As for the lower-bit models, an implementation of the QLP quantization technology has consistently superior scores over all baselines. This proves the advantages of the quantization-aware training approaches over the post-training quantization methods.

To ensure a fair comparison between the ternary quantization approach and FP16 LLaMA LLM in various sizes, the models were pretrained on the RedPajama dataset (i.e., an open dataset for training large language models) for 100 billion tokens.

The zero-shot performance on a range of language tasks was evaluated, including ARC-Easy, ARC-Challenge, Hellaswag, Winogrande, PIQA, OpenbookQA, and BoolQ. Also, validation perplexity is reported on the WikiText2 and C4 datasets.

The runtime GPU memory and latency of both LLaMA LLM and the ternary quantization approach are compared. The results are measured using the FasterTransformer3 codebase, which is well-optimized for LLM inference latency on GPU devices. The 2-bit kernel from Ladder is also integrated for the ternary quantization approach. The time per output token is reported.

TABLE 4

| | | Memory | Latency | |
|---|---|---|---|---|
| Models | Size | (GB)↓ | (ms)↓ | PPL↓ |
| LLaMA LLM | 700M | 2.08 (1.00x) | 1.18 (1.00x) | 12.33 |
| Ternary Q | 700M | 0.80 (2.60x) | 0.96 (1.23x) | 12.87 |
| LLaMA LLM | 1.3B | 3.34 (1.00x) | 1.62 (1.00x) | 11.25 |
| Ternary Q | 1.3B | 1.14 (2.93x) | 0.97 (1.67x) | 11.29 |
| LLaMA LLM | 3B | 7.89 (1.00x) | 5.07 (1.00x) | 10.04 |
| Ternary Q | 3B | 2.22 (3.55x) | 1.87 (2.71x) | 9.91 |
| Ternary Q | 3.9B | 2.38 (3.32x) | 2.11 (2.40x) | 9.62 |

Table 4 summarizes the perplexity and the cost for the ternary quantization approach (Ternary Q) and LLaMA LLM. It shows that the ternary quantization approach starts to match full precision LLaMA LLM at 3B model size in terms of perplexity, while being 2.71 times faster and using 3.55 times less GPU memory. In particular, the ternary quantization approach with a 3.9B model size is 2.4 times faster, consumes 3.32 times less memory, but performs significantly better than LLaMA LLM 3B.

TABLE 5

| Models | Size | ARCe | ARCc | HS | BQ | OQ | PQ | WGe | Avg. |
|---|---|---|---|---|---|---|---|---|---|
| LLAMA | 700M | 54.7 | 23.0 | 37.0 | 60.0 | 20.2 | 68.9 | 54.8 | 45.5 |
| LLM | | | | | | | | | |
| Ternary Q | 700M | 51.8 | 21.4 | 35.1 | 58.2 | 20.0 | 68.1 | 55.2 | 44.3 |
| LLAMA | 1.3B | 56.9 | 23.5 | 38.5 | 59.1 | 21.6 | 70.0 | 53.9 | 46.2 |
| LLM | | | | | | | | | |
| Ternary Q | 1.3B | 54.9 | 24.2 | 37.7 | 56.7 | 19.6 | 68.8 | 55.8 | 45.4 |
| LLAMA | 3B | 62.1 | 25.6 | 43.3 | 61.8 | 24.6 | 72.1 | 58.2 | 49.7 |
| LLM | | | | | | | | | |
| Ternary Q | 3B | 61.4 | 28.3 | 42.9 | 61.5 | 26.6 | 71.5 | 59.3 | 50.2 |
| Ternary Q | 3.9B | 64.2 | 28.7 | 44.2 | 63.5 | 24.2 | 73.2 | 60.5 | 51.2 |

Table 5 reports the detailed results of the zero-shot accuracy on the end tasks. The pipeline from lm-evaluation-harness4 is followed to perform the evaluation. The results show that the performance gap between the ternary quantization approach and LLaMA LLM narrows as the model size increases. Notably, the ternary quantization approach can match the performance of the full precision baseline starting from a 3B size. Similar to the observation of the perplexity, the end-task results reveal that the ternary quantization approach 3.9B outperforms LLaMA LLM 3B with lower memory and latency cost. This demonstrates that the ternary quantization approach is a Pareto improvement over the state-of-the-art LLM models.

Memory and Latency. To evaluate cost, the model size was scaled up to 7B, 13B, and 70B. With ULP weight quantization approaches, the speed increases with the size of the model. For example, the ternary quantization approach 70B is 4.1 times faster than the LLaMA LLM baseline.

This is because the time cost for nn.Linear grows with the model size. Memory consumption follows a similar trend, as the embedding remains full precision and its memory proportion is smaller for larger models. Both latency and memory were measured with a 2-bit kernel, so there is still room for optimization to further reduce the cost.

Energy. The energy consumption of the arithmetic operations energy consumption of both the ternary quantization approach and LLaMA LLM are estimated. The focus here is mainly on the calculation for matrix multiplication, since it contributes the most to the cost of LLMs. The majority of the ternary quantization approach is INT8 addition calculation, while LLaMA LLM consists of both FP16 addition and FP16 multiplication. The ternary quantization approach saves 71.4 times arithmetic operations energy consumption for matrix multiplication on 7 nm chips. The end-to-end energy cost for models with 512 tokens is reported. The results show that as the model size scales, the ternary quantization approach becomes increasingly more efficient in terms of energy consumption compared to the FP16 LLaMA LLM baseline. This is due to the fact that the percentage of nn.Linear grows with the model size, while the cost from other components is smaller for larger models.

Throughput. The throughput of the ternary quantization approach and LLaMA LLM are compared. There are 70B parameters on two 80 GB A100 cards, using pipeline parallelism so that LLaMA LLM 70B could be run on the devices. The batch size is increased until the GPU memory limit was reached, with a sequence length of 512. Table 6 shows that the ternary quantization approach 70B can support up to 11 times the batch size of LLaMA LLM, resulting an 8.9 times higher throughput.

TABLE 6

| | | | | Throughput | |
|---|---|---|---|---|---|
| Models | Size | Max Batch Size | | (tokens/s) | |
| LLaMA LLM | 70B | 16 | (1.0x) | 333 | (1.0x) |
| Ternary Q | 70B | 176 | (11.0x) | 2977 | (8.9x) |

The ternary quantization approach is enabling a new scaling law with respect to model performance and inference cost. For the discussion hereafter, the following equivalence between different model sizes in ternary quantization approach and F16-bit:
13B the ternary quantization approach is more efficient, in terms of latency, memory usage and energy consumption, than 3B FP16 LLM.
30B the ternary quantization approach is more efficient, in terms of latency, memory usage and energy consumption, than 7B FP16 LLM.
70B the ternary quantization approach is more efficient, in terms of latency, memory usage and energy consumption, than 13B FP16 LLM.

Training with 2T Tokens. The number of training tokens is a factor for LLMs. To test the scalability of the ternary quantization approach in terms of tokens, the ternary quantization approach model with 2T tokens is trained using the following data recipe of StableLM-3B, which is the state-of-the-art open-source 3B model. Both models were evaluated on a benchmark that consists of Winogrande, PIQA, SciQ, LAMBADA, and ARC-easy. The zero-shot accuracy is reported in Table 7.

TABLE 7

| | | | | | | ARC- | |
|---|---|---|---|---|---|---|---|
| Models | Tokens | Winogrande | PIQA | SciQ | LAMBADA | easy | Avg. |
| StableLM-3B | 2T | 64.56 | 76.93 | 90.75 | 66.09 | 67.78 | 73.22 |
| Ternary Q 3B | 2T | 66.37 | 78.40 | 91.20 | 67.63 | 68.12 | 74.34 |

For tasks measured with accuracy and normalized accuracy, the average of the two is taken. The results of StableLM 3b at 2T tokens are taken directly from its technical report. The findings show that the ternary quantization approach achieves a superior performance on all end tasks, indicating that LLMs that employ the ternary quantization approach also have strong generalization capabilities.

As noted above, the existing machine-learning approaches have room for improvement regarding resource consumption (e.g., energy) and efficiency (e.g., computations). To address these and other shortcomings of the existing machine-learning techniques, an ultra-low-precision (“ULP”) quantization technology of machine learning models is described herein,

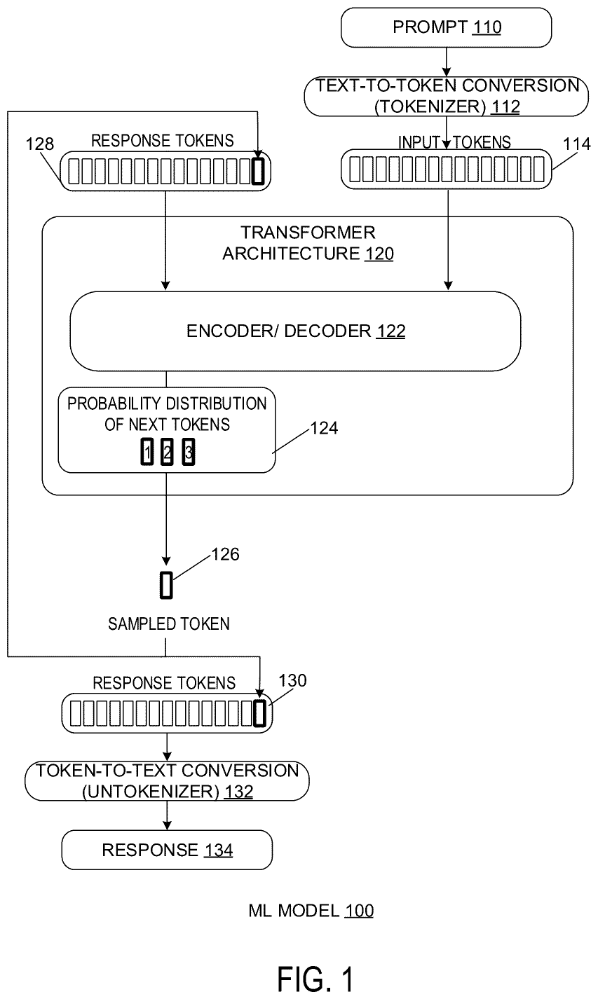

FIG. 1 shows a schematic view of an example machine learning (ML) model 100 with a transformer architecture, which may be suitable for an implementation of the ultra-low precision weight quantization technology described herein. The ML model 100 with a transformer architecture may be implemented as a large language model (LLM). The ML model 100 may be implemented by a processing circuitry (e.g., processing circuitry 600 discussed below) including memory storing instructions that when executed cause the processing circuitry. There are three sections of the depicted ML model 100 with a transformer architecture: input embedding section, transformer architecture 120, and output section.

The input embedding section includes a prompt 110, a tokenizer 112, and an embedder 114. The prompt 110 may be employed to receive the initial text input that guides the output of a trained LLM. When training the LLM, the prompt 110 may be replaced with a training corpus, which is a dataset of content (e.g., text, images, etc.) used to pre-train the model.

Tokenizer 112 performs text-to-token conversion, which is simply called tokenization herein. This is when raw text from the prompt 110 or a training corpus is split into tokens (words or subwords).

The embedder 114 maps (i.e., generates token embeddings) each token to a dense vector (e.g., 768 dimensions) using a learnable embedding matrix. In addition, embedder 114 may add positional information (i.e., positional encodings). Since transformers have no recurrence, positional information is added to token embeddings using sine and cosine functions of different frequencies.

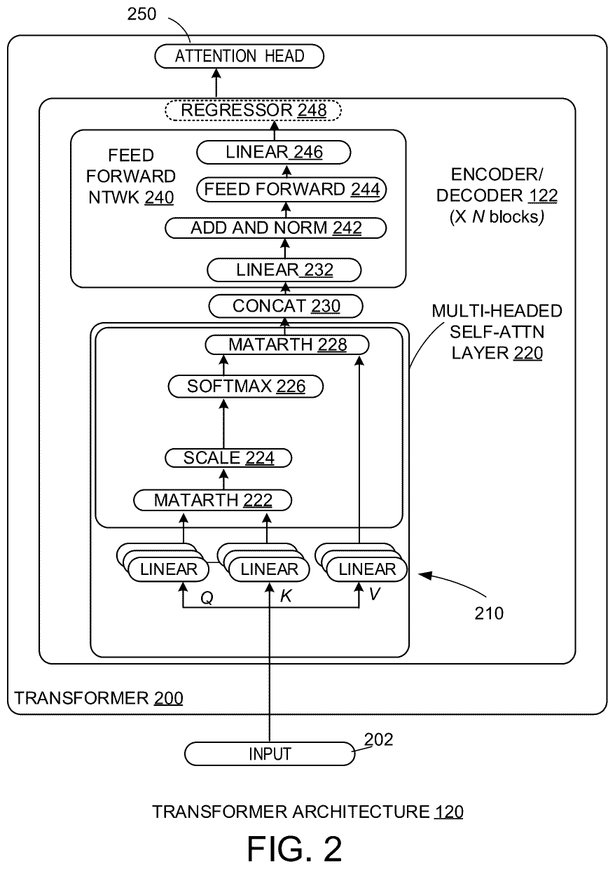

The transformer architecture 120 includes an encoder/decoder 122, or optionally an encoder only, or decoder only. The encoder/decoder 122 a multi-head self-attention and position-wise feed-forward network (FFN) as sublayers within attention unit, and these sublayers may be repeated as a unit one or more times. These sub-layers are described with regard to FIG. 2.

In some implementations, the functionality may be distinct and separate for each other. The encoder and decoder stacks in transformer-based LLMs often serve distinct but complementary roles. Typically, the encoder processes the entire input sequence in parallel using unmasked self-attention, creating rich, bidirectional contextual representations. In contrast, the decoder typically generates output sequentially, employing masked self-attention to maintain a causal structure and cross-attention to focus on relevant parts of the encoder's output.

While encoders are used in models for tasks like classification or masked language modeling, decoders are central to autoregressive text generation. Encoder-decoder models combine both for sequence-to-sequence tasks. Key differences include the decoder's additional cross-attention layer, its typically autoregressive operation limiting parallelization during inference, and its causal information flow. Despite these differences, both stacks use similar building blocks of attention mechanisms and feed-forward networks, working together to enable the powerful capabilities of LLMs across a wide range of natural language tasks.

As depicted, the encoder/decoder 122 produces a probability distribution 124 of the next tokens. This signifies the likelihood of each possible token appearing next in a sequence, determined by the model's learned parameters and conditional probabilities. This distribution is pivotal for tasks like text generation, guiding the model to predict the most probable next token based on the context provided by preceding tokens.

The output section includes a sampled token 126, output response tokens 130, an untokenizer 132, and a response 134. The sampled token 126 is the token selected from the probability distribution 124 of possible tokens as the next token in a sequence. The sampled token 126 is sampled based on its likelihood according to the model's learned parameters and the context provided by preceding tokens. Sampling tokens allows the model to generate diverse and fluent text, as it can choose different tokens from the distribution each time it generates text.

The sampled token 126 is inserted into feedback response tokens 128 and the output response tokens 130. As its name implies, the feedback response tokens 128 feedback into the encoder/decoder 122. Response tokens 130 are the tokens generated by the model in response to a given prompt or input. These tokens constitute the text produced by the model based on its understanding of the input and its learned language patterns. Response tokens are generated sequentially, with each token being selected based on the model's internal representations and the probability distribution of possible tokens given the preceding context. The sequence of response tokens forms the output text generated by the model in response to the input.

The untokenizer 132 receives the response tokens 130 and converts the tokens into text. Thus, the untokenizer 132 produces response 134 from the response tokens 130. Response 134 may be a sequence of text.

The ML model 100 may be implemented as a large language model (LLM) having weight values of the LLM at 1-bit or 1.58-bit precision. The LLM being configured to receive tokenized input (e.g., tokenized input from embedder 114) in the form of an input sequence of input tokens (e.g., from the tokenizer 112) and generate tokenized output (e.g., sampled token 126) in the form of an output sequence (e.g., response tokens 130) of output tokens. The ML model 100 may be implemented as a LLM having activation input values at 8-bit precision.

FIG. 2 shows a schematic view of an example internal configuration of a transformer architecture 120 of FIG. 1. The depicted transformer architecture 120 includes at least one transformer 200 that receive input 202.

Input 202 may include an activation input matrix of activation input values. The activation input matrix typically refers to a matrix that represents the activation input values to the model's activation functions. These activation functions are mathematical operations applied to the inputs at each layer of the neural network, allowing the model to learn complex patterns and representations from the input data. The activation input matrix contains the values that are fed into these activation functions, which are then transformed to produce the activations of the neurons in the network. This matrix plays a role in the forward propagation process of the neural network, ultimately influencing the model's predictions and behavior.

The activation input values represent the transformed and abstracted representations of the initial tokenized input of the input embedding section as depicted in FIG. 1 that emerges as the input progresses through the layers of the neural network. The activation values encode increasingly abstract and higher-level features of the tokenized input as it traverses through the network, ultimately influencing the model's ability to generate predictions or responses based on the tokenized input.

Transformer 200 includes one or more encoders/decoders, like encoder/decoder 122 as shown in FIG. 1, though alternatively may be encoder-only or decoder only. The encoder/decoder 122 includes a first linearization layer 210, a self-attention mechanism 220, and feed-forward network (ntwk) 240. The output from the encoder/decoder 122 feeds into another attention head 250 of, perhaps, another encoder/decoder of the transformer 200. The first linearization layer 210 is provided on an input side of the self-attention mechanism 220.

As shown, the self-attention mechanism 220 receives an input 202 that is passed through a normalization layer (not shown) before passing through a first linearization layer 210 in which vectors for queries Q, keys K, and values V are projected into the matrix arithmetic (MatArth) layer 222. The MatArth layer 222 performs matrix arithmetic (e.g., matrix multiplication, matrix addition) on the keys and query values. The output is then scaled by scaling layer 224 and passed through softmax layer 226.

A matrix arithmetic (MatArth) layer 228 of the self-attention mechanism 220 performs matrix arithmetic (e.g., matrix multiplication, matrix addition) on the linear projection of the values vector to produce an output. The process of the self-attention mechanism 220 occurs in parallel for each attention head of the multiple attention heads, and the results of all attention heads are concatenated in concatenation (Concat) layer 230. The concat layer 230 and their linear projection is transmitted to feed-forward network 240. This linear projection is performed by another linearization layer 232.

The feed-forward network 240 includes an addition and normalization (add and norm) layer 242, a feed-forward neural network 244, and a regressor node 248. The addition and normalization layer 242 of the feed-forward network 240 receives the concat layer 230 and their linear projection and performs residual connection and layer normalization. That is, the addition and normalization layer 242 performs an element-wise addition of the input and output of the feed-forward layer, allowing the model to learn residual functions and alleviating the vanishing gradient problem. In addition, a layer normalization is applied after the residual connection to normalize the activations across the features for each sample independently, stabilizing the training process, reducing internal covariate shift, and improving the flow of information and gradients throughout the network.

The output from the addition and normalization layer 242 is received by the feed-forward neural network 248, which includes at least two fully connected layers. The feed-forward neural network 248 includes an activation function selected from a group consisting of Rectified Linear Units (ReLU) and Gaussian Error Linear Unit (GELU).

The feed-forward neural network 248 includes another linearization layer 246 on the output side of the neural network 244. The output of the feed forward neural network 244 is routed through a regressor node 248 of an attention head, the regressor node 248 being configured to output a scalar value. It will be appreciated that during training, a prediction of the scalar value is compared to ground truth for the scalar value, and loss function is used to train the feed forward network using a suitable backpropagation algorithm. The multi-headed self-attention layer 220 and feed forward network 240 form one block of encoder/decoder 122, and it will be appreciated that multiple blocks of encoder/decoder 122 may be chained together.

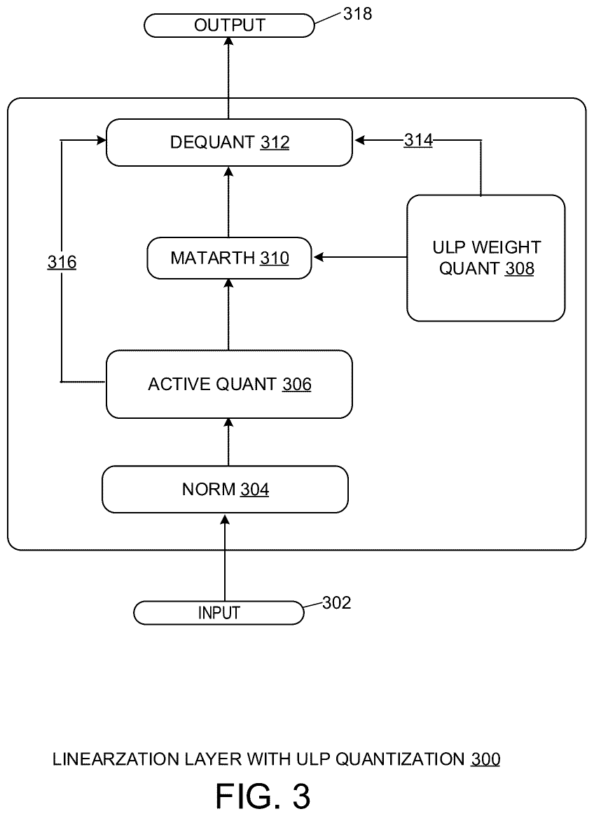

FIG. 3 shows a schematic view of an example linearization layer 300 that employs an implementation of the ULP weight quantization technology as described herein. The first linearization layer 210, the other linearization layer 232, and the second linearization layer 246 shown in FIG. 2 may be implemented in accordance with the example linearization layer 300 that employs ULP weight quantization depicted in FIG. 3. The second linearization layer 246 is on an input side of the feed-forward neural network 248.

The linearization layer 300 that employs ULP weight quantization includes a normalization layer 304, activation quantization layer 306, ULP weights quantization layer 308, a matrix arithmetic (MatArth) layer 310, and a dequantization layer 312. During a training operation or inference operation of the machine learning model (e.g., machine learning model 100) with a transformer architecture (e.g., transformer architecture 120), the linearization layer (e.g., linearization layers 210, 232, 246, and 300) is configured to perform ULP weight quantization operations and other related operations.

For example, the linearization layer 300 is configured to receive an activation input matrix of activation input values from input 302. A normalization (Norm) layer 304 receives that activation input matrix and performs layer normalization (i.e., LayerNorm). LayerNorm is a normalization technique that normalizes the activations across the features (e.g., neurons) in each layer of the deep neural network, helping to stabilize and accelerate training by mitigating internal covariate shift in very deep models.

The linearization layer 300 is configured to perform activation quantization (Active Quant) 306 on the normalized received activation input matrix of activation input values. The layer normalization function is performed before the activation quantization 306 to preserve the variance after quantization.

The activation quantization 306 reduces precision of the activation input values of the received activation input matrix to a reduced precision that is less than the first precision. For example, the activation input values may have a first precision of floating-point 32 (FP32) and the activation quantization 306 reduces to a lower precision, such as floating-point 16 (FP16). In another example, the activation input values may have a first precision of floating-point 16 (FP16) and the activation quantization 306 reduces to a lower precision, such as floating-point 8 (FP8). In still another example, the activation input values may have a first precision of floating-point 16 or 8 (FP 16 or FP8) and the activation quantization 306 reduces to a lower precision, such as floating-point 6 or 4 (FP6 or FP4).

In addition, the activation quantization 306 employs the reduced-precision activation input values to compute the matrix arithmetic result. This functionality is illustrated by an arrow leading from the activation quantization 306 and pointing towards the matrix arithmetic (MatArth) layer 310.

In some implementations of the technology described herein, the operation of the activation quantization 306 might not be employed. In such implementations, the activation input values of the received activation input matrix remain at a first precision (such as, FP32, FP16, or FP8). Thus, the matrix arithmetic (MatArth) layer 310 operates on the activation input values of the received activation input matrix at a first precision.

Linearization layer 300 is configured to obtain a weight matrix of weight values. The weight values of the obtained weight matrix have an initial precision that is greater than a lower precision that allows for only two or three possible values. That is, the lower precision is binary or ternary options. For example, the initial precision of the weight values may be floating-point 16 (FP16), which is greater than the lower precision that allows for only two or three possible values.

The linearization layer 300 is configured to perform ultra-low precision (ULP) weight quantization on the weight values of the obtained weight matrix. In some implementations, ULP weight quantization layer 308 performs a binarization by quantizing each of the weight values in the weight matrix to a corresponding selected value from a predefined set of binary quantized weight values. That is, the set of the binary quantized weight values has one of two values. The set of 1 and 0 are two values that may compose an example of a predefined set of binary quantized weight values. The set of 1 and −1 are two values that may compose an example of a predefined set of binary quantized weight values.

In some implementations, ULP weight quantization layer 308 performs a ternarization by quantizing each of the weight values in the weight matrix to a corresponding selected value from a predefined set of ternary quantized weight values. That is, the set of the ternary quantized weight values has one of three values. The set of 2, 1, and 0 are three values that may compose an example of a predefined set of ternary quantized weight values. The set of 1, 0, and −1 are three values that may compose an example of a predefined set of ternary quantized weight values.

Linearization layer 300 is configured to compute a matrix arithmetic result based on at least a portion of the weight matrix with the quantized weight values and at least a portion of the activation input matrix. For example, the matrix arithmetic (MatArth) layer 310 receives the weight matrix with the quantized weight values from the ULP weight quantization layer 308 and the activation input values of the received activation input matrix remain. The activation input values received by the matrix arithmetic layer 310 may be first precision or a reduce precision.

In some implementations, the matrix arithmetic computed by the matrix arithmetic (MatArth) layer 310 includes multiplying at least a portion of the weight matrix with the quantized weight values by at least a portion of the activation input matrix. The multiplication involves matrix multiplication of at least a portion of the weight matrix with the quantized weight values by at least a portion of the activation input matrix.

In some implementations, the matrix arithmetic computed by the matrix arithmetic (MatArth) layer 310 includes summing at least a portion of the weight matrix with the quantized weight values with at least a portion of the activation input matrix. The summation involves matrix addition of at least a portion of the weight matrix with the quantized weight values with at least a portion of the activation input matrix.

In some implementations, the matrix arithmetic computed by the matrix arithmetic (MatArth) layer 310 includes integer addition of at least a portion of the weight matrix with the quantized weight values with at least a portion of the activation input matrix. The integer addition saves orders of energy cost for machine learning models.

The linearization layer 300 is further configured to obtain a scaling factor (β), which is used after ULP weight quantization to reduce an l2 error between the real-valued and the ULP quantized weights. The scaling factor refers to the relationship between the model's size, typically measured by the number of parameters or computational resources, and its performance on various natural language processing tasks. Increasing the model size often leads to better performance, but with diminishing returns and increased computational requirements. The proper scaling factor involves trade-offs between model performance, computational resources, and efficiency, and helps in making informed decisions about model size, resource allocation, and performance expectations.

The linearization layer 300 is configured to calculate a mean of the matrix of weight parameters. Herein, the mean is represented by lowercase alpha (α) for binarization and gamma (γ) for ternarization. Equations 3 and 6 offer ways to calculate alpha and gamma, respectively.

Linearization layer 300 is configured to adjust the matrix arithmetic result, before output, based on the scaling factor and the mean of the matrix of weight parameters. This is depicted in FIG. 3, by the dequantization layer 312 receiving the scaling factor 316 from the activation quantization layer 306 and the mean 314 of the matrix of weight parameters from the ULP weight quantization layer 306.

With the scaling factor 316 and the mean 314, the dequantization layer 312 can dequantize the results from the operation of the matrix arithmetic (MatArth) layer 310. In other implementations, the dequantization layer 312 rescales the output activations (i.e., low-precision activations) with scaling factor 316 and the mean 314 to dequantize the output activation to the original precision (i.e., their first precision).

The linearization layer 300 is further configured to output the matrix arithmetic result to the self-attention mechanism or the feed forward network. As depicted, output 318 represents sending the results of the linearization layer 300 onward to either the self-attention mechanism or the feed forward network. Such results may include the results of the matrix arithmetic (MatArth) layer 310, an adjusted (e.g., dequantized) version of the results of the matrix arithmetic (MatArth) layer 310, and/or a first precision version of the activation output.

In some implementations, processing circuitry may be distributed across multiple computing devices each configured to implement an instance of the ML model 100. In these distributed implementations, the weight matrix and activation input matrix are divided into a plurality of weight subgroups and activation input subgroups, respectively. Each of the computing devices receive a corresponding weight subgroup and activation input subgroup for performing matrix arithmetic in parallel at least during training. In these distributed implementations, each computing device is configured to perform weight subgroup quantization and weight subgroup normalization, and activation subgroup quantization and activation subgroup normalization during the parallel matrix arithmetic.

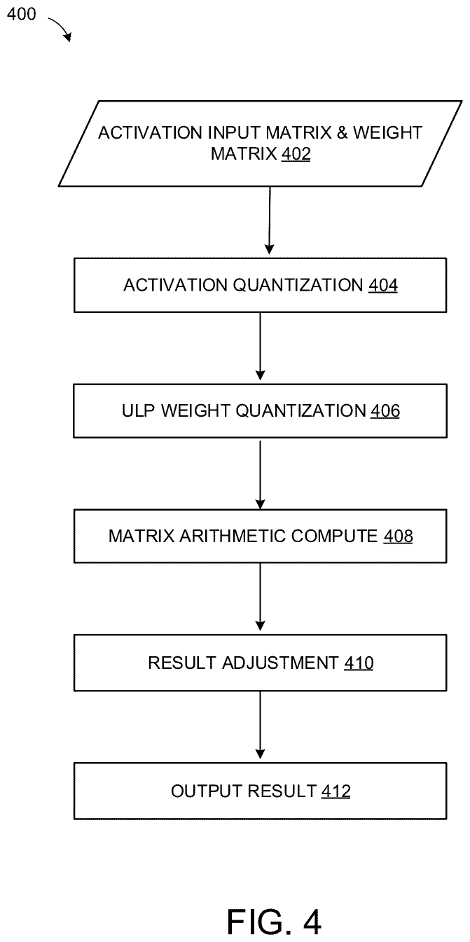

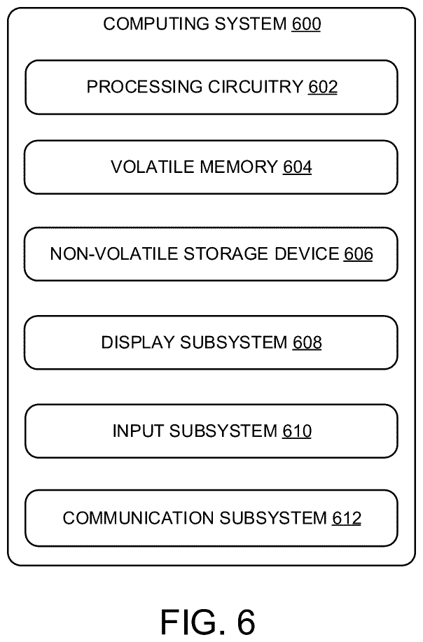

FIG. 4 shows a flowchart of a computerized method 400 according to one example implementation of the present disclosure. Method 400 may be implemented by the hardware and software of computing system 600 described herein, by the processing circuitry 600 of FIG. 6 described hereafter, or by other suitable hardware and software.

Method 400 facilitates training operation of or inference operation of a machine learning model (e.g., ML model 100) having a transformer architecture (e.g., transformer architecture 120). The machine learning model includes a linearization layer (e.g., linearization layers 210, 232, 246, and/or 300), a self-attention mechanism (e.g., self-attention mechanism 220), and a feed forward network (e.g., feed-forward network 240). Method 400 being performed at the linearization layer (e.g., linearization layers 210, 232, 246, and/or 300).

At 402, method 400 may include receiving an activation input matrix of activation input values and obtaining a weight matrix of weight values.

At 404, method 400 may include activation quantization. In this action, method 400 may reduce precision of the activation input values of the received activation input matrix to a reduced precision that is less than the first precision and employ the reduced-precision activation input values to compute a matrix arithmetic result.

At 406, the method may further include perform ultra-low precision (ULP) weight quantization on the weight values of the obtained weight matrix. In some implementations, this action performs a binarization by quantizing each of the weight values in the weight matrix to a corresponding selected value from a predefined set of binary quantized weight values. In other implementations, this action performs a ternarization by quantizing each of the weight values in the weight matrix to a corresponding selected value from a predefined set of ternary quantized weight values.

At 408, the method may further include computing a matrix arithmetic result based on at least a portion of the weight matrix with the quantized weight values and at least a portion of the activation input matrix.

In some implementations, the matrix arithmetic of this action is computed by multiplying at least a portion of the weight matrix with the quantized weight values by at least a portion of the activation input matrix. The multiplication involves matrix multiplication of at least a portion of the weight matrix with the quantized weight values by at least a portion of the activation input matrix.

In some implementations, the matrix arithmetic of this action is computed by summing at least a portion of the weight matrix with the quantized weight values with at least a portion of the activation input matrix. The summation involves matrix addition of at least a portion of the weight matrix with the quantized weight values with at least a portion of the activation input matrix.

In some implementations, the matrix arithmetic of this action is computed by integer addition of at least a portion of the weight matrix with the quantized weight values with at least a portion of the activation input matrix. The integer addition saves orders of energy cost for machine learning models.

At 410, method 400 may further include adjusting the matrix arithmetic result, before output, based on the scaling factor and the mean of the matrix of weight parameters. To that end, this action may include obtaining a scaling factor and calculating a mean of the matrix of weight parameters.

At 412, the method may further include outputting the matrix arithmetic result to the self-attention mechanism or the feed forward network.

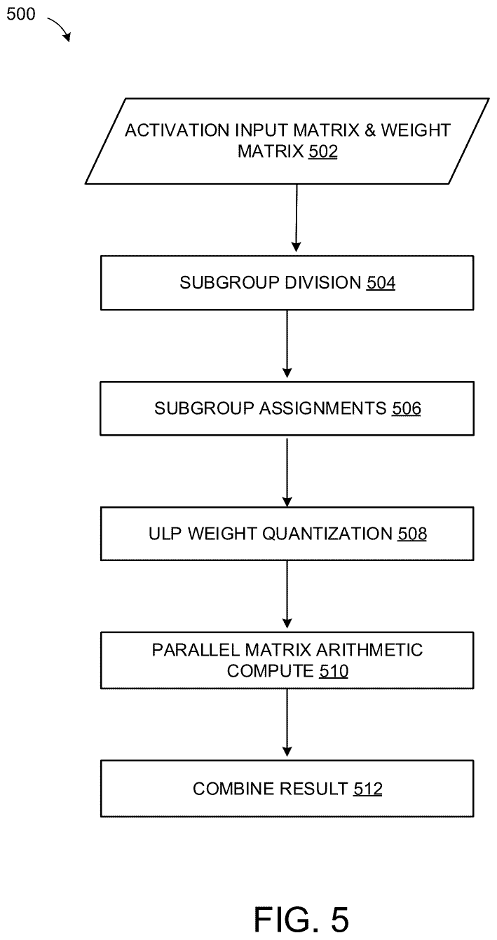

FIG. 5 shows a flowchart of a computerized method 500 according to one example implementation of the present disclosure. Method 500 may be implemented by the hardware and software of computing system 600 described herein, by the processing circuitry 600 of FIG. 6 described hereafter, or by other suitable hardware and software.

Method 500 facilitates training operation of or inference operation of a machine learning model (e.g., ML model 100) having a transformer architecture (e.g., transformer architecture 120). The machine learning model includes a linearization layer (e.g., linearization layers 210, 232, 246, and/or 300), a self-attention mechanism (e.g., self-attention mechanism 220), and a feed forward network (e.g., feed-forward network 240). Method 500 may be implemented by processing circuitry distributed across multiple computing devices each configured to implement an instance of the machine learning model.

At 502, method 500 may include receiving an activation input matrix of activation input values and obtaining a weight matrix of weight values.

At 504, method 500 may include dividing the weight matrix and activation input matrix into a plurality of weight subgroups and activation input subgroups, respectively.

At 506, the method may further include assigning a subgroup to each computing device. This action may include receiving, by each of the computing devices, a corresponding weight subgroup and activation input subgroup.

At 508, the method may further include performing ultra-low precision (ULP) weight quantization in a distributed fashion across the computing devices. In some implementations, this action may include performing, by each of the computing devices, binarization by quantizing each of the weight values in the weight matrix of the received weight subgroup to a corresponding selected value from a predefined set of binary quantized weight values. In other implementations, this action may include performing, by each of the computing devices, ternarization by quantizing each of the weight values in the weight matrix of the received weight subgroup to a corresponding selected value from a predefined set of ternary quantized weight values.

At 510, the method may further include computing, by each of the computing devices, a matrix arithmetic operation in parallel at least during training. In some implementations, a result of the parallel matrix arithmetic operation is based on at least a portion of a weight matrix with the quantized weight values of the received weight subgroup multiplied by at least a portion of the activation input matrix of the received activation input subgroup. In some implementations, a result of the parallel matrix arithmetic operation is based on at least a portion of a weight matrix with the quantized weight values of the received weight subgroup summed with at least a portion of the activation input matrix of the received activation input subgroup.

At 512, the method may further include combining the results of the parallel matrix arithmetic operations for each corresponding weight subgroup and activation input subgroup.

In some embodiments, the methods and processes described herein may be tied to a computing system of one or more computing devices. In particular, such methods and processes may be implemented as a computer-application program or service, an application-programming interface (API), a library, and/or other computer-program products.

FIG. 6 schematically shows a non-limiting embodiment of a computing system 600 that can enact one or more of the methods and processes described above. Computing system 600 is shown in simplified form. Computing system 600 may embody other computing system embodiments described above. Components of computing system 600 may be included in one or more personal computers, server computers, tablet computers, home-entertainment computers, network computing devices, video game devices, mobile computing devices, mobile communication devices (e.g., smartphone), and/or other computing devices, and wearable computing devices such as smart wristwatches and head mounted augmented reality devices.

Computing system 600 includes processing circuitry 602, volatile memory 604, and a non-volatile storage device 606. Computing system 600 may optionally include a display subsystem 608, input subsystem 610, communication subsystem 612, and/or other components not shown.

Processing circuitry typically includes one or more processors, which are physical devices configured to execute instructions. For example, the processing circuitry may be configured to execute instructions that are part of one or more applications, programs, routines, libraries, objects, components, data structures, or other logical constructs. Such instructions may be implemented to perform a task, implement a data type, transform the state of one or more components, achieve a technical effect, or otherwise arrive at a desired result.

The processing circuitry may include one or more physical processors configured to execute software instructions. Additionally or alternatively, the processing circuitry may include one or more hardware logic circuits or firmware devices configured to execute hardware-implemented logic or firmware instructions. Processors of the processing circuitry 602 may be single-core or multi-core, and the instructions executed thereon may be configured for sequential, parallel, and/or distributed processing. Individual components of the processing circuitry optionally may be distributed among two or more separate devices, which may be remotely located and/or configured for coordinated processing. For example, aspects of the computing system disclosed herein may be virtualized and executed by remotely accessible, networked computing devices configured in a cloud-computing configuration. In such a case, these virtualized aspects are run on different physical processing circuitry of various different machines, it will be understood. These different physical processing circuitries of the different machines will be understood to be collectively encompassed by processing circuitry 602.

Non-volatile storage device 606 includes one or more physical devices configured to hold instructions executable by the processing circuitry to implement the methods and processes described herein. When such methods and processes are implemented, the state of non-volatile storage device 606 may be transformed—e.g., to hold different data.

Non-volatile storage device 606 may include physical devices that are removable and/or built in. Non-volatile storage device 606 may include optical memory, semiconductor memory, and/or magnetic memory, or other mass storage device technology. Non-volatile storage device 606 may include nonvolatile, dynamic, static, read/write, read-only, sequential-access, location-addressable, file-addressable, and/or content-addressable devices. It will be appreciated that non-volatile storage device 606 is configured to hold instructions even when power is cut to the non-volatile storage device 606.

Volatile memory 604 may include physical devices that include random access memory. Volatile memory 604 is typically utilized by processing circuitry 602 to temporarily store information during processing of software instructions. It will be appreciated that volatile memory 604 typically does not continue to store instructions when power is cut to the volatile memory 604.

Aspects of processing circuitry 602, volatile memory 604, and non-volatile storage device 606 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” may be used to describe an aspect of computing system 600 typically implemented in software by a processor to perform a particular function using portions of volatile memory, which function involves transformative processing that specially configures the processor to perform the function. Thus, a module, program, or engine may be instantiated via processing circuitry 602 executing instructions held by non-volatile storage device 606, using portions of volatile memory 604. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “cprogram,” and “engine” may encompass individual or groups of executable files, data files, libraries, drivers, scripts, database records, etc.

When included, display subsystem 608 may be used to present a visual representation of data held by non-volatile storage device 606. The visual representation may take the form of a graphical user interface (GUI). As the herein described methods and processes change the data held by the non-volatile storage device, and thus transform the state of the non-volatile storage device, the state of display subsystem 608 may likewise be transformed to visually represent changes in the underlying data. Display subsystem 608 may include one or more display devices utilizing virtually any type of technology. Such display devices may be combined with processing circuitry 602, volatile memory 604, and/or non-volatile storage device 606 in a shared enclosure, or such display devices may be peripheral display devices.

When included, input subsystem 610 may comprise or interface with one or more user-input devices such as a keyboard, mouse, touch screen, camera, or microphone.

When included, communication subsystem 612 may be configured to communicatively couple various computing devices described herein with each other, and with other devices. Communication subsystem 612 may include wired and/or wireless communication devices compatible with one or more different communication protocols. As non-limiting examples, the communication subsystem may be configured for communication via a wired or wireless local- or wide-area network, broadband cellular network, etc. In some embodiments, the communication subsystem may allow computing system 600 to send and/or receive messages to and/or from other devices via a network such as the Internet.

The following paragraphs describe additional aspects of the present disclosure. According to a first aspect, a computer system is provided, comprising: processing circuitry including memory storing instructions that when executed cause the processing circuitry to implement: a machine learning model having a transformer architecture, the machine learning model including a linearization layer, a self-attention mechanism, and a feed forward network, wherein during a training operation or inference operation of the machine learning model: the linearization layer is configured to: receive an activation input matrix of activation input values; obtain a weight matrix of weight values; perform ultra-low precision (ULP) quantization by quantizing each of the weight values in the weight matrix to a corresponding selected value from a predefined set of binary or ternary quantized weight values; compute a matrix arithmetic result based on at least a portion of the weight matrix with the quantized weight values and at least a portion of the activation input matrix; and output the matrix arithmetic result to the self-attention mechanism or the feed forward network. In this aspect, the linearization layer can be a first linearization layer and can be provided on an input side of the self-attention mechanism; the feed forward network can include a neural network that includes at least two fully connected layers; and the feed forward network further can include a second linearization layer on an input side of the neural network. In this aspect, the neural network of the feed forward network can include an activation function selected from a group consisting of Rectified Linear Units (ReLU) and Gaussian Error Linear Unit (GELU). In this aspect, each of the activation input values of the received activation input matrix can have a first precision and the linearization layer can be further configured to: reduce precision of the activation input values of the received activation input matrix to a reduced precision that is less than the first precision; and employ the reduced-precision activation input values to compute the matrix arithmetic result. In this aspect, the linearization layer can be further configured to: obtain a scaling factor; calculate a mean of the matrix of weight parameters; and adjust the matrix arithmetic result, before output, based on the scaling factor and the mean of the matrix of weight parameters. In this aspect, the machine learning model can be a large language model (LLM) wherein the weight values of the LLM are 1-bit or 1.58-bit precision, and the LLM can be configured to receive tokenized input in the form of an input sequence of input tokens and generate tokenized output in the form of an output sequence of output tokens. In this aspect, the activation input values of the LLM can be 8-bit precision. In this aspect, the matrix arithmetic result can be computed by multiplying at least a portion of the weight matrix with the quantized weight values by at least a portion of the activation input matrix. In this aspect, the matrix arithmetic result can be computed by summing at least a portion of the weight matrix with the quantized weight values with at least a portion of the activation input matrix. In this aspect, the processing circuitry can be distributed across multiple computing devices each configured to implement an instance of the machine learning model, and the weight matrix and activation input matrix can be divided into a plurality of weight subgroups and activation input subgroups, respectively, with each of the computing devices receiving a corresponding weight subgroup and activation input subgroup for performing matrix arithmetic in parallel at least during training, and each computing device can be configured to perform weight subgroup quantization and weight subgroup normalization, and activation subgroup quantization and activation subgroup normalization during the parallel matrix arithmetic.

According to another aspect, a method that facilitates a training operation of or inference operation of a machine learning model having a transformer architecture is provided, the machine learning model including a linearization layer, a self-attention mechanism, and a feed forward network, the method, performed at the linearization layer, comprising: receiving an activation input matrix of activation input values; obtaining a weight matrix of weight values; performing binarization or ternarization by quantizing each of the weight values in the weight matrix to a corresponding selected value from a predefined set of binary or ternary quantized weight values; computing a matrix arithmetic result based on at least a portion of the weight matrix with the quantized weight values and at least a portion of the activation input matrix; and outputting the matrix arithmetic result to the self-attention mechanism or the feed forward network. In this aspect, each of the activation input values of the received activation input matrix can have a first precision, and the method, performed at the linearization layer, can further comprise: reducing precision of the activation input values of the received activation input matrix to a reduced precision that is less than first precision; and employing the reduced-precision activation input values to compute the matrix arithmetic result. In this aspect, the method can further comprise: obtaining a scaling factor; calculating a mean of the matrix of weight parameters; and adjusting the matrix arithmetic result, before output, based on the scaling factor and the mean of the matrix of weight parameters. In this aspect, the machine learning model can be a large language model (LLM) and the weight values of the LLM can be 1-bit or 1.58-bit precision, and the method can further comprise receiving tokenized input in the form of an input sequence of input tokens and generating tokenized output in the form of an output sequence of output tokens. In this aspect, the LLM can have activation input values of 8-bit precision. In this aspect, the matrix arithmetic result can be computed by multiplying at least a portion of the weight matrix with the quantized weight values by at least a portion of the activation input matrix. In this aspect, the matrix arithmetic result can be computed by summing at least a portion of the weight matrix with the quantized weight values with at least a portion of the activation input matrix. In this aspect, the processing circuitry can be distributed across multiple computing devices each configured to implement an instance of the machine learning model, and the method can further comprise: dividing the weight matrix and activation input matrix into a plurality of weight subgroups and activation input subgroups, respectively; receiving, by each of the computing devices, a corresponding weight subgroup and activation input subgroup; and performing, by each of the computing devices, matrix arithmetic in parallel at least during training, at least in part by executing, by each of the computing devices, weight subgroup quantization and weight subgroup normalization, and activation subgroup quantization and activation subgroup normalization during the parallel matrix arithmetic. In this aspect, a computer-readable medium storing a trained machine learning model that was produced, at least in part, in accordance with the method of this aspect, is provided.

According to another aspect, a method is provided that facilitates training operation of or inference operation of a machine learning model having a transformer architecture, the machine learning model including a linearization layer, a self-attention mechanism, and a feed forward network, the method being implemented by processing circuitry distributed across multiple computing devices each configured to implement an instance of the machine learning model, the method, performed at the linearization layer, the method comprising: obtaining an activation input matrix of activation input values; obtaining a weight matrix of weight values; dividing the weight matrix and activation input matrix into a plurality of weight subgroups and activation input subgroups, respectively; receiving, by each of the computing devices, a corresponding weight subgroup and activation input subgroup; performing, by each of the computing devices, binarization or ternarization by quantizing each of the weight values in the weight matrix of the received weight subgroup to a corresponding selected value from a predefined set of binary or ternary quantized weight values; computing, by each of the computing devices, a matrix arithmetic operation in parallel at least during training, wherein a result of the parallel matrix arithmetic operation is based on at least a portion of a weight matrix with the quantized weight values of the received weight subgroup multiplied by or summed with at least a portion of the activation input matrix of the received activation input subgroup; and combining the results of the parallel matrix arithmetic operations for each corresponding weight subgroup and activation input subgroup.

“And/or” as used herein is defined as the inclusive or V, as specified by the following truth table:

| A | B | A ∨ B |
|---|---|---|
| True | True | True |
| True | False | True |
| False | True | True |
| False | False | False |

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A computer system comprising:
processing circuitry including memory storing instructions that when executed cause the processing circuitry to implement:
a machine learning model having a transformer architecture, the machine learning model including a linearization layer, a self-attention mechanism, and a feed forward network, wherein during a training operation or inference operation of the machine learning model:
the linearization layer is configured to:
receive an activation input matrix of activation input values;
obtain a weight matrix of weight values;
perform ultra-low precision (ULP) quantization by quantizing each of the weight values in the weight matrix to a corresponding selected value from a predefined set of binary or ternary quantized weight values;
compute a matrix arithmetic result based on at least a portion of the weight matrix with the quantized weight values and at least a portion of the activation input matrix; and
output the matrix arithmetic result to the self-attention mechanism or the feed forward network.

2. The computer system of claim 1, wherein
the linearization layer is a first linearization layer and is provided on an input side of the self-attention mechanism;
the feed forward network includes a neural network that includes at least two fully connected layers; and
the feed forward network further includes a second linearization layer on an input side of the neural network.

3. The computer system of claim 2, the neural network of the feed forward network includes an activation function selected from a group consisting of Rectified Linear Units (ReLU) and Gaussian Error Linear Unit (GELU).

4. The computer system of claim 1, wherein each of the activation input values of the received activation input matrix have a first precision and the linearization layer is further configured to:
reduce precision of the activation input values of the received activation input matrix to a reduced precision that is less than the first precision; and
employ the reduced-precision activation input values to compute the matrix arithmetic result.

5. The computer system of claim 1, wherein the linearization layer is further configured to:
obtain a scaling factor;
calculate a mean of the matrix of weight parameters; and
adjust the matrix arithmetic result, before output, based on the scaling factor and the mean of the matrix of weight parameters.

6. The computer system of claim 1, wherein the machine learning model is a large language model (LLM) and the weight values of the LLM are 1-bit or 1.58-bit precision, the LLM being configured to receive tokenized input in the form of an input sequence of input tokens and generate tokenized output in the form of an output sequence of output tokens.

7. The computer system of claim 6, wherein the activation input values of the LLM are 8-bit precision.

8. The computer system of claim 1, the matrix arithmetic result being computed by multiplying at least a portion of the weight matrix with the quantized weight values by at least a portion of the activation input matrix.

9. The computer system of claim 1, the matrix arithmetic result being computed by summing at least a portion of the weight matrix with the quantized weight values with at least a portion of the activation input matrix.

10. The computer system of claim 1, wherein the processing circuitry is distributed across multiple computing devices each configured to implement an instance of the machine learning model, and the weight matrix and activation input matrix are divided into a plurality of weight subgroups and activation input subgroups, respectively, with each of the computing devices receiving a corresponding weight subgroup and activation input subgroup for performing matrix arithmetic in parallel at least during training, and wherein each computing device is configured to perform weight subgroup quantization and weight subgroup normalization, and activation subgroup quantization and activation subgroup normalization during the parallel matrix arithmetic.

11. A method that facilitates a training operation of or inference operation of a machine learning model having a transformer architecture, the machine learning model including a linearization layer, a self-attention mechanism, and a feed forward network, the method, performed at the linearization layer, comprising:
receiving an activation input matrix of activation input values;
obtaining a weight matrix of weight values;
performing binarization or ternarization by quantizing each of the weight values in the weight matrix to a corresponding selected value from a predefined set of binary or ternary quantized weight values;
computing a matrix arithmetic result based on at least a portion of the weight matrix with the quantized weight values and at least a portion of the activation input matrix; and
outputting the matrix arithmetic result to the self-attention mechanism or the feed forward network.

12. The method of claim 11, wherein each of the activation input values of the received activation input matrix have a first precision, the method, performed at the linearization layer, further comprising:
reducing precision of the activation input values of the received activation input matrix to a reduced precision that is less than first precision; and
employing the reduced-precision activation input values to compute the matrix arithmetic result.

13. The method of claim 11, the method, performed at the linearization layer, further comprising:
obtaining a scaling factor;
calculating a mean of the matrix of weight parameters; and
adjusting the matrix arithmetic result, before output, based on the scaling factor and the mean of the matrix of weight parameters.

14. The method of claim 11, wherein the machine learning model is a large language model (LLM) and the weight values of the LLM are 1-bit or 1.58-bit precision, the method further comprising receiving tokenized input in the form of an input sequence of input tokens and generate tokenized output in the form of an output sequence of output tokens.

15. The method of claim 14, wherein the LLM has activation input values of 8-bit precision.

16. The method of claim 11, the matrix arithmetic result being computed by multiplying at least a portion of the weight matrix with the quantized weight values by at least a portion of the activation input matrix.

17. The method of claim 11, the matrix arithmetic result being computed by summing at least a portion of the weight matrix with the quantized weight values with at least a portion of the activation input matrix.

18. The method of claim 11, wherein processing circuitry is distributed across multiple computing devices each configured to implement an instance of the machine learning model, the method further comprises:
dividing the weight matrix and activation input matrix into a plurality of weight subgroups and activation input subgroups, respectively;
receiving, by each of the computing devices, a corresponding weight subgroup and activation input subgroup; and
performing, by each of the computing devices, matrix arithmetic in parallel at least during training, at least in part by executing, by each of the computing devices, weight subgroup quantization and weight subgroup normalization, and activation subgroup quantization and activation subgroup normalization during the parallel matrix arithmetic.

19. A computer-readable medium storing a trained machine learning model that was produced, at least in part, in accordance with the method of claim 11.

20. A method that facilitates training operation of or inference operation of a machine learning model having a transformer architecture, the machine learning model including a linearization layer, a self-attention mechanism, and a feed forward network, the method being implemented by processing circuitry distributed across multiple computing devices each configured to implement an instance of the machine learning model, the method, performed at the linearization layer, comprising:
obtaining an activation input matrix of activation input values;
obtaining a weight matrix of weight values;
dividing the weight matrix and activation input matrix into a plurality of weight subgroups and activation input subgroups, respectively;
receiving, by each of the computing devices, a corresponding weight subgroup and activation input subgroup;
performing, by each of the computing devices, binarization or ternarization by quantizing each of the weight values in the weight matrix of the received weight subgroup to a corresponding selected value from a predefined set of binary or ternary quantized weight values;
computing, by each of the computing devices, a matrix arithmetic operation in parallel at least during training, wherein a result of the parallel matrix arithmetic operation is based on at least a portion of a weight matrix with the quantized weight values of the received weight subgroup multiplied by or summed with at least a portion of the activation input matrix of the received activation input subgroup; and
combining the results of the parallel matrix arithmetic operations for each corresponding weight subgroup and activation input subgroup.
